(19) United States
(12) Patent Application Publication
(10) Pub. No.: US 2026/0074181 A1
(43) Pub. Date: Mar. 12, 2026

(54) BATTERY WITH LITHIUM METAL COATING

(71) Applicant: Apple Inc., Cupertino, CA (US)

(72) Inventors: Jian Hong, Cupertino, CA (US); Jinjun Shi, San Jose, CA (US)

(21) Appl. No.: 19/255,476

(22) Filed: Jun. 30, 2025

Related U.S. Application Data
(60) Provisional application No. 63/693,578, filed on Sep. 11, 2024.

(51) Int. Cl. H01M 4/04; C25D 3/42

(52) U.S. Cl. CPC H01M 4/0452; C25D 3/42

(57) ABSTRACT

A battery pre-lithiation assembly includes an enclosure and an electrode disposed in the enclosure. The electrode assembly includes a current collector, active material disposed on the current collector, and perforations extending through the active material and the current collector. The battery pre-lithiation assembly also includes a lithium metal coating on an interior of the enclosure. The perforations are configured to enable migration of Li+ ions from the lithium metal coating to the electrode via a pre-lithiation process when the enclosure receives an electrolyte.

### CROSS-REFERENCE TO RELATED APPLICATION

This application claims priority to U.S. Provisional Application No. 63/693,578, filed Sep. 11, 2024, which is incorporated by reference herein in its entirety.

### BACKGROUND

The present disclosure relates generally to batteries, such as secondary or rechargeable batteries (e.g., lithium-ion batteries), configured to power a load, such as an electronic device (e.g., consumer electronic device). More specifically, the present disclosure relates to pre-lithiation assemblies and processes of such batteries.

Certain batteries, such as those described above, may undergo a pre-lithiation process causing lithium cations (Li+ ions) to react with an anode of the battery during formation of the battery (e.g., prior to using the battery for powering a load). Pre-lithiation processes may employ oxidation-reduction (redox) reactions to reduce or mitigate initial active lithium loss that occurs during cycling stages (e.g., early cycling stages) of the battery, improve local voltage uniformity, and/or maintain battery stability and performance. Unfortunately, traditional pre-lithiation processes may be cumbersome, expensive, inadequate, and/or ineffective. Accordingly, it is now recognized that improved systems and methods are desired.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a battery pre-lithiation assembly includes an enclosure and an electrode disposed in the enclosure. The electrode assembly includes a current collector, active material disposed on the current collector, and perforations extending through the active material and the current collector. The battery pre-lithiation assembly also includes a lithium metal coating on an interior surface of the enclosure. The perforations are configured to enable migration of Li+ ions from the lithium metal coating to the electrode via a pre-lithiation process when the enclosure receives an electrolyte.

In another embodiment, a battery pre-lithiation assembly includes an enclosure, an anode disposed in the enclosure, and a cathode disposed in the enclosure. The anode includes an anode current collector, anode active material disposed on the anode current collector, and first perforations extending through the anode current collector and the anode active material. The cathode includes a cathode current collector, cathode active material disposed on the cathode current collector, and second perforations extending through the cathode current collector and the cathode active material. The battery pre-lithiation assembly also includes a lithium metal coating on an interior surface of the enclosure, wherein the first perforations and the second perforations are configured to enable migration of Li+ ions from the lithium metal coating to the anode via a pre-lithiation process.

In another embodiment, a method of manufacturing a battery includes disposing perforations through a current collector of an electrode and an active material of the electrode, where the active material is disposed on the current collector. The method also includes coating an interior surface of an enclosure with a lithium metal, disposing the electrode in the enclosure, and disposing an electrolyte in the enclosure to initiate a pre-lithiation process in which Li+ ions are transferred from the lithium metal to the electrode by way of the perforations.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a block diagram of a pre-lithiation assembly employed in a pre-lithiation process to form a battery configured to power a load, such as the electronic device of FIG. 1, according to embodiments of the present disclosure;

FIG. 3 is a cross-sectional view of a cathode of the pre-lithiation assembly of FIG. 2, where the cathode includes perforations through a cathode current collector and a cathode active material on opposing sides of the cathode current collector, according to embodiments of the present disclosure;

FIG. 4 is a cross-sectional view of an anode of the pre-lithiation assembly of FIG. 2, where the anode includes perforations through an anode current collector and an anode active material on opposing sides of the anode current collector, according to embodiments of the present disclosure; and

FIG. 5 is a cross-sectional view of the pre-lithiation assembly of FIG. 2, where the lithium metal coating is disposed on interior surfaces of an enclosure, according to embodiments of the present disclosure;

FIG. 6 is a cross-sectional view of a battery formed from the pre-lithiation assembly of FIG. 5, according to embodiments of the present disclosure; and

FIG. 7 is a process flow diagram illustrating a method of manufacturing a battery, according to embodiments of the present disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1 % of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on).

The present disclosure relates generally to embodiments of a battery, such as secondary or rechargeable battery (e.g., lithium-ion battery), and more specifically to embodiments of a pre-lithiation assembly and process of the battery, where the pre-lithiation assembly includes perforated electrodes and a lithium metal coating disposed on one or more interior surfaces of an enclosure in which the perforated electrodes are disposed. In general, the pre-lithiation assembly and process is employed in formation of the battery to reduce initial active lithium loss and improve local voltage uniformity, battery performance, battery stability, and energy density over traditional systems and techniques.

The battery (e.g., lithium-ion battery) may include, among other features, electrodes (e.g., at least one anode and at least one cathode), at least one separator, an electrolyte, and an enclosure in which the electrodes, the at least one separator, and the electrolyte are disposed. The electrodes and the separator(s) of the battery may be referred to herein as an electrode assembly. In some embodiments, the electrode assembly is wound into a jelly roll, while in other embodiments, the electrode assembly is arranged in a stacked configuration or other type of configuration.

The battery may be cycled through various discharging and charging sequences during a lifetime of the battery. In traditional configurations, initial active lithium loss may occur in certain of such cycles, which can affect battery stability, performance, and/or energy density. In accordance with the present disclosure, a pre-lithiation assembly and process may be employed (e.g., during formation of the battery) that introduces a lithium source (e.g., a lithium metal coating), such as a sacrificial lithium source, that mitigates initial active lithium loss and improves local voltage uniformity, battery performance, and battery stability, among other technical benefits.

As described in detail with reference to the drawings, the lithium source may include a lithium metal coating disposed on one or more interior surfaces of an enclosure (e.g., battery enclosure). Further, the electrodes may include perforations therethrough. For example, each electrode may include a current collector and active material disposed on opposing sides of the current collector, where the perforations extend through the current collector and the active material. The perforations in the electrodes and pores in the separator form channels promoting movement of lithium cations (Li+ ions) associated with or corresponding to the lithium metal coating about an interior of the enclosure. For example, introduction of electrolyte into the enclosure may cause the movement of the Li+ ions from the lithium metal coating toward the anodes during an electrolyte aging portion of the pre-lithiation process. The perforations also enable desirable diffusion and wetting of the electrodes by the electrolyte. An oxidation-reduction (redox) reaction between the Li+ ions and the anode may occur such that active lithium is transferred to the anodes, thereby reducing, negating, or otherwise preventing initial active lithium loss and/or local voltage non-uniformity.

As described above and in more detail below, presently disclosed systems and techniques enable improved local voltage uniformity, reduced initial active lithium loss, and improved battery performance, stability, and energy density over traditional systems and techniques. Further, presently disclosed systems and techniques may be less expensive and cumbersome than traditional techniques. Further still, employing the lithium metal coating(s) on the interior surface(s) of the enclosure may reduce an amount of space taken by the lithium source within the interior of the enclosure relative to traditional configurations, thereby improving a volumetric energy density of the battery formed from the pre-lithiation assembly. It should be noted that, while certain embodiments of the present disclosure are discussed in the context of a lithium-ion (Li-ion) battery, similar systems and techniques may be employed in other batteries with other material compositions. These and other aspects of the present disclosure are described in detail below with reference to the drawings.

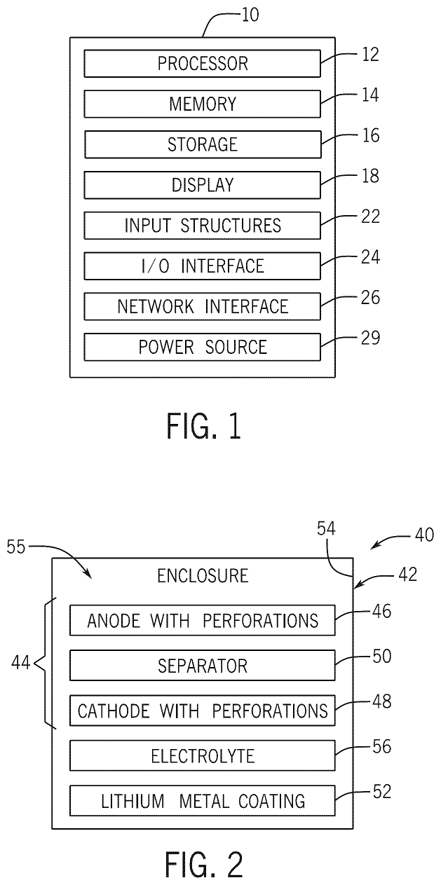

Continuing now with the drawings, FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer, a portable electronic or handheld electronic device such as a wireless electronic device or smartphone, a tablet, a wearable electronic device, and other similar devices. In additional or alternative embodiments, the electronic device 10 may include an access point, such as a base station, a router (e.g., a wireless or Wi-Fi router), a hub, a switch, and so on. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector, a universal serial bus (USB), or other similar connector and protocol. The network interface 26 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3rd generation (3G) cellular network, universal mobile telecommunication system (UMTS), 4th generation (4G) cellular network, Long Term Evolution (LTE) cellular network, Long Term Evolution License Assisted Access (LTE-LAA) cellular network, 5th generation (5G) cellular network, and/or New Radio (NR) cellular network, a 6th generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the electronic device 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

The power source 29 of the electronic device 10 may include any suitable source of power, such as a rechargeable lithium polymer (Li-poly) or lithium-ion (Li-ion) battery and/or an alternating current (AC) power converter. In accordance with the present disclosure, the battery of the power source 29 may be formed at least in part from on a pre-lithiation assembly and process. The pre-lithiation assembly may include an enclosure, an electrode assembly within an interior of the enclosure, and a lithium metal coating on one or more interior surfaces defining the interior of the enclosure. Further, the electrode assembly may include various electrodes, such as various anodes and cathodes, having perforations therethrough. Introduction of electrolyte into the enclosure of the pre-lithiation assembly may cause movement of Li+ ions from the lithium metal coating on the interior surfaces of the enclosure toward the anodes during an electrolyte aging portion of the pre-lithiation process. The perforations in the electrodes may facilitate diffusion of the electrolyte, wetting of the electrodes by the electrolyte, and the movement of the Li+ ions about the interior of the enclosure and toward the anodes. A redox reaction between the Li+ ions and the anodes may occur such that active lithium is transferred to the anodes, thereby reducing, negating, or otherwise preventing initial active lithium loss and/or local voltage non-uniformity that may otherwise occur during formation of the battery and/or initial cycles of the battery. In some embodiments, at least a portion of the pre-lithiation assembly is a precursor to the battery. In other words, various componentry of the pre-lithiation assembly, including the enclosure and the electrode assembly, may also be componentry of the battery following the pre-lithiation process. Accordingly, pre-lithiation assembly may be referred to as a battery pre-lithiation assembly in certain instances of the present disclosure. These and other aspects of the present disclosure are described in greater detail below.

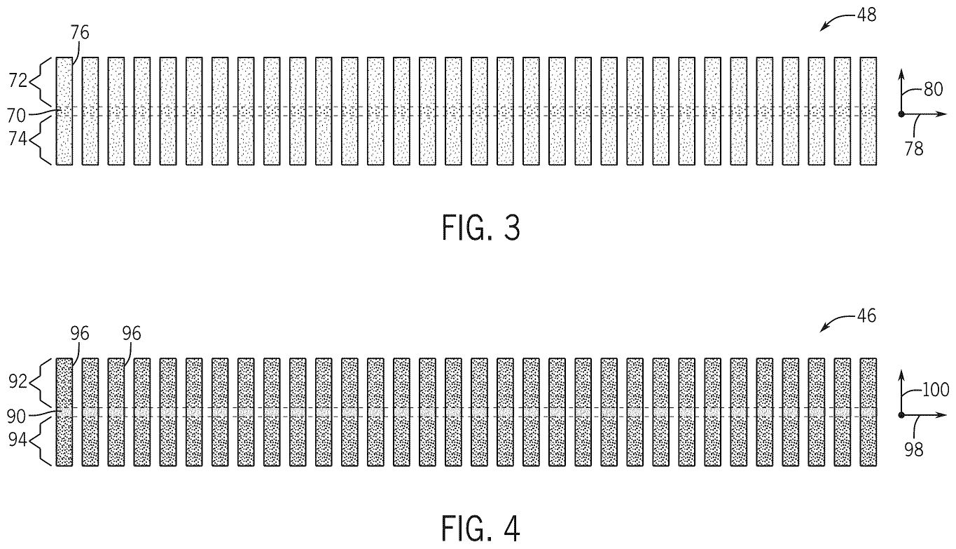

FIG. 2 is a block diagram of an embodiment of a pre-lithiation assembly 40 employed in a pre-lithiation process to form a battery configured to power a load, such as the electronic device 10 of FIG. 1. In the illustrated embodiment, the pre-lithiation assembly 40 includes an enclosure 42, an electrode assembly 44 having an anode 46, a cathode 48, and a separator 50, and a lithium metal coating 52, among other possible features. In accordance with the present disclosure, the lithium metal coating 52 may be disposed on one or more interior surfaces 54 defining an interior 55 of the enclosure 42. As shown, the separator 50 is disposed between the anode 46 and the cathode 48. While only one instance of the anode 46 and one instance of the cathode 48 are illustrated in FIG. 2 for clarity, it should be understood that multiple instances of the anode 46 and multiple instances of the cathode 48 may be employed in certain embodiments. Further, the electrode assembly 44 may include a stacked configuration (e.g., where the anode(s) 46, the cathode(s) 48, and the separator(s) 50 are stacked one on top of the other) or a jelly roll configuration (e.g., where the anode(s) 46, the cathode(s) 48, and the separator(s) 50 are wound about an axis) in accordance with the present disclosure.

During a pre-lithiation process employing the pre-lithiation assembly 40, an electrolyte 56 may be introduced into the interior 55 of the enclosure 42 of the pre-lithiation assembly 40. Introduction of the electrolyte 56 may cause movement of Li+ ions from the lithium metal coating 52, through the interior 55 of the enclosure 42, and toward the anode 46. As described in detail below with reference to later drawings, the anode 46 and the cathode 48 may include perforations therethrough that improve wetting of the anode 46 and the cathode 48 by the electrolyte 56, along with migration of the Li+ ions from the lithium metal coating 52, about the interior 55 of the enclosure 42, and toward the anode 46. Further, the separator 50 may include a porous separator, where pores of the separator 50 are configured to improve migration of the Li+ ions from the lithium metal coating 52, about the interior 55 of the enclosure 42, and toward the anode 46. During an electrolyte aging portion of the pre-lithiation process, redox reactions between the Li+ ions and the anode 46 may occur such that active lithium is transferred to the anode 46, thereby reducing, negating, or mitigating initial active lithium loss and improving local voltage uniformity and/or battery stability and performance.

FIG. 3 is a cross-sectional view of an embodiment of the cathode 48 of the pre-lithiation assembly 40 of FIG. 2. In the illustrated embodiment, the cathode 48 includes a cathode current collector 70, a first cathode active material layer 72 on a first side of the cathode current collector 70, a second cathode active material layer 74 on a second side of the cathode current collector 70 opposing the first side, and perforations 76 formed through the cathode current collector 70, the first cathode active material layer 72, and the second cathode active material layer 74. For example, the first cathode active material layer 72 and the second cathode active material layer 74 may include metal oxides, such as lithium cobalt oxide, lithium manganese oxide, lithium iron phosphate, and/or lithium nickel manganese cobalt oxide, and the cathode current collector 70 may include aluminum.

As shown, each of the cathode current collector 70, the first cathode active material layer 72, and the second cathode active material layer 74 extends in a lateral direction 78. The perforations 76 extend through the cathode 48 (e.g., through the cathode current collector 70, the first cathode active material layer 72, and the second cathode active material layer 74) in a vertical direction 80 transverse to (e.g., perpendicular to) the lateral direction 78. Further, sizes and spacing of the perforations 76 may cause a removal of only 1-1.5% of the active material corresponding to the first cathode active material layer 72 and the second cathode active material layer 74, such that any reduction in volumetric energy density caused by the perforations 76 is relatively low. In other embodiments, more than 1.5% of the active material corresponding to the first cathode active material layer 72 and the second cathode active material layer 74 may be removed via the perforations 76. As previously described, the perforations 76 are configured to enable, promote, and/or improve (e.g., relative to traditional configurations) migration of Li+ ions from a lithium metal coating, through an interior of an enclosure, and toward anode(s) of the pre-lithiation assembly. In some embodiments, additional perforations may be disposed through the cathode 48, such as through the cathode active material layers 72, 74, in the lateral direction 78 (e.g., transverse to the vertical direction 80 and the perforations 76 extending along the vertical direction 80).

FIG. 4 is a cross-sectional view of an embodiment of the anode 46 of the pre-lithiation assembly 40 of FIG. 2. In the illustrated embodiment, the anode 46 includes an anode current collector 90, a first anode active material layer 92 on a first side of the anode current collector 90, a second anode active material layer 94 on a second side of the anode current collector 90 opposing the first side, and perforations 96 through the anode current collector 90, the first anode active material layer 92, and the second anode active material layer 94. For example, the first anode active material layer 92 and the second anode active material layer 94 may include carbon-based materials, such as graphite and/or silicon, and the anode current collector 90 may include copper.

As shown, each of the anode current collector 90, the first anode active material layer 92, and the second anode active material layer 94 extends in a lateral direction 98. The perforations 96 extend through the anode 46 (e.g., through the anode current collector 90, the first anode active material layer 92, and the second anode active material layer 94) in a vertical direction 100 transverse to (e.g., perpendicular to) the lateral direction 98. Further, sizes and spacing of the perforations 96 may cause a removal of only 1-1.5% of the active material corresponding to the first anode active material layer 92 and the second anode active material layer 94, such that any reduction in volumetric energy density caused by the perforations 96 is relatively low. In other embodiments, more than 1.5% of the active material corresponding to the first anode active material layer 92 and the second anode active material layer 94 may be removed via the perforations 96. As previously described, the perforations 96 are configured to enable, promote, and/or improve (e.g., relative to traditional configurations) migration of Li+ ions from a lithium metal coating, through an interior of an enclosure, and toward anode(s) of the pre-lithiation assembly. In some embodiments, additional perforations may be disposed through the anode 46, such as through the anode active material layers 92, 94, in the lateral direction 98 (e.g., transverse to the vertical direction 100 and the perforations 96 extending along the vertical direction 100).

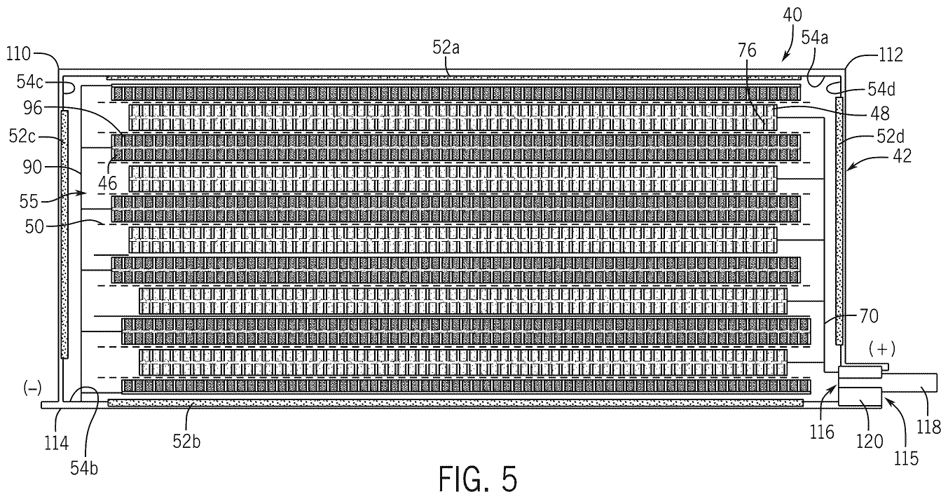

FIG. 5 is a cross-sectional view of an embodiment of the pre-lithiation assembly 40 of FIG. 2, where the lithium metal coating 52 is disposed on the interior surfaces 54 of the enclosure 42. For example, the interior surfaces 54 of the enclosure 42 include an upper interior surface 54a, a lower interior surface 54b opposing the upper interior surface 54a, a first side interior surface 54c, and a second side interior surface 54d opposing the first side interior surface 54c. The lithium metal coating 52 may include a first lithium metal coating portion 52a disposed on the upper interior surface 54a, a second lithium metal coating portion 52b disposed on the lower interior surface 54b, a third lithium metal coating portion 52c disposed on the first side interior surface 54c, and a fourth lithium metal coating portion 52d disposed on the second side interior surface 54d. In certain instances of the present disclosure, the various portions 52a, 52b, 52c, 52d of the lithium metal coating 52 may be referred to as various coatings (e.g., first lithium metal coating 52a, second lithium metal coating 52b, third lithium metal coating 52c, fourth lithium metal coating 52d, etc.). Although not shown in the illustrated embodiment, fifth and sixth lithium metal coating portions (or “coatings”) may be disposed on front and back interior surfaces of the enclosure 42. In general, by employing the lithium metal coating(s) 52 (e.g., the lithium metal coating portions 52a, 52b, 52c, 52d) on the interior surface(s) 54 (e.g., interior surfaces 54a, 54b, 54c, 54d) of the enclosure 42, an amount of space taken by the lithium source within the interior 55 of the enclosure 42 may be reduced relative to traditional configurations, thereby improving a volumetric energy density of the battery formed from the pre-lithiation assembly 40.

As shown, the lithium metal coating portions 52a, 52b, 52c, 52d may not be disposed across an entirety of the interior surfaces 54a, 54b, 54c, 54d of the enclosure 42. For example, the upper interior surface 54a and the first side interior surface 54c may intersect to form a first corner 110 in which neither the first lithium metal coating portion 52a nor the third lithium metal coating portion 52c is disposed, the upper interior surface 54a and the second side interior surface 54d may intersect to form a second corner 112 in which neither the first lithium metal coating portion 52a nor the fourth lithium metal coating portion 52d is disposed, and the lower interior surface 54b and the first side interior surface 54c may intersect to form a third corner 114 in which neither the second lithium metal coating portion 52b nor the third lithium metal coating portion 52c is disposed. In general, the lithium metal coating portions 52a, 52b, 52c, 52d may extend across at least a majority of the interior surfaces 54a, 54b, 54c, 54d. As an example, the first lithium metal coating portion 52a may extend across 50%, 75%, 90%, or 95% of the upper interior surface 54a, the second lithium metal coating portion 52b may extend across 50%, 75%, 90%, or 95% of the lower interior surface 54b, the third lithium metal coating portion 52c may extend across 50%, 75%, 90%, or 95% of the first side interior surface 54c, and the fourth lithium metal coating portion 52d may extend across 50%, 75%, 90%, or 95% of the second side interior surface 54d. In other embodiments, at least one of the lithium metal coating portions 52a, 52b, 52c, or 52d covers an entirety of the respective interior surface 54a, 54b, 54c, or 54d.

In some embodiments, a battery terminal assembly 115 is disposed in a fourth corner 116 at or adjacent to ends of (or an intersection between) the bottom interior surface 54b and the second side interior surface 54d, and neither the second lithium metal coating portion 52b nor the fourth lithium metal coating portion 52d is disposed in the fourth corner 116. As shown, the battery terminal assembly 115 includes a terminal 118 (e.g., positive terminal) and at least one electrical insulator 120 between the terminal 118 and the enclosure 42, where the terminal 118 is electrically coupled with the cathode current collectors 70 (e.g., cathode current collectors tabs) of the cathodes 48. Additionally or alternatively, the anode current collectors 90 (e.g., anode current collector tabs) of the anodes 46 are electrically coupled with the enclosure 42 in the illustrated embodiment, such that the enclosure 42 forms an additional terminal (e.g., negative terminal).

As previously described, electrolyte may be introduced to the interior 55 of the enclosure 42 to initiate the pre-lithiation process of the pre-lithiation assembly 40. For example, the electrolyte may cause movement of Li+ ions from the lithium metal coating 52 (e.g., lithium metal coating portions 52a, 52b, 52c, 52d) toward the anodes 46 during an electrolyte aging portion of the pre-lithiation process. The perforations 76 in the cathodes 48, the perforations 96 in the anodes 46, and pores in the separator(s) 50 facilitate movement (e.g., diffusion) of the electrolyte and the Li+ ions corresponding to the lithium metal coating 52 (e.g., lithium metal coating portions 52a, 52b, 52c, 52d) about the interior 55 of the enclosure 42.

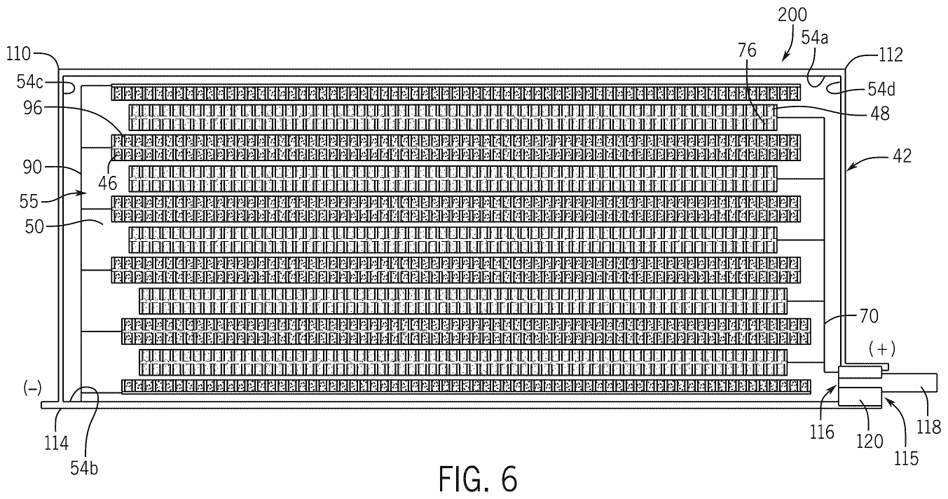

As previously described, redox reactions between the Li+ ions and the anodes 46 may occur such that active lithium is transferred to the anodes 46, thereby reducing, negating, or otherwise preventing initial active lithium loss. That is, upon completion of the pre-lithiation process (including the electrolyte aging portion thereof), all or most of the lithium metal coating portions 52a, 52b, 52c, 52d may be depleted from the interior surface 54a, 54b, 54c, or 54d of the enclosure 42 as the active lithium is transferred to the anodes 46. For example, FIG. 6 is a cross-sectional view of an embodiment of a battery 200 formed from the pre-lithiation assembly 40 of FIG. 5. In the illustrated embodiment, the battery 200 includes the same or similar features as the pre-lithiation assembly 40 in FIG. 5, except that the lithium metal coating portions 52a, 52b, 52c, 52d are absent from the interior surface 54a, 54b, 54c, or 54d of the enclosure 42, as the active lithium has been transferred to the anodes 46 in the battery 200 illustrated in FIG. 6.

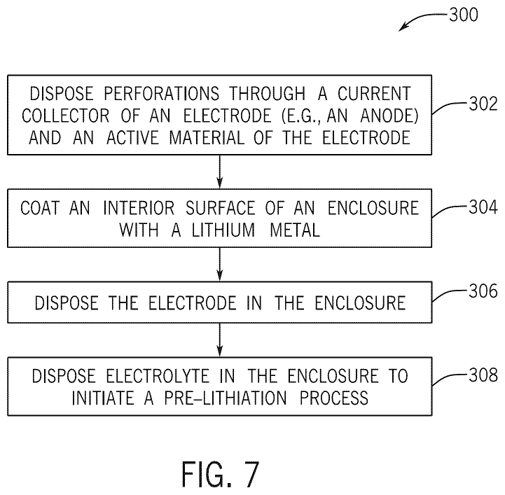

FIG. 7 is a process flow diagram illustrating an embodiment of a method 300 of manufacturing a battery. In the illustrated embodiment, the method 300 includes disposing (block 302) perforations through a current collector of an electrode (e.g., an anode) and an active material of the electrode. As previously described, the active material may be disposed on opposing sides of the current collector. In some embodiments, the method 300 includes disposing additional perforations through an additional current collector of an additional electrode (e.g., a cathode) and an additional active material of the additional electrode. Any number of anodes and cathodes may be employed in accordance with the present disclosure.

The method 300 also includes coating (block 304) an interior surface of an enclosure with a lithium metal. For example, the lithium metal coating may be disposed across an entirety of the interior surface or less than the entirety of the interior surface (e.g., a majority of the interior surface). In some embodiments, lithium metal is coated on multiple interior surfaces of the enclosure, such as four or more (e.g., six) interior surfaces of the enclosure.

The method 300 also includes disposing (block 306) the electrode (e.g., the anode) in the enclosure. As previously, multiple electrodes (e.g., the anode and the cathode, multiple anodes and multiple cathodes, etc.) may be employed, each of which being disposed in the enclosure. Further, one or more separators may be employed between adjacent electrode pairs (e.g., between each pair of anode and cathode). As previously described, the one or more separators may include pores. In general, the pores may be smaller than the perforations through the electrodes. For example, a cross-sectional width of each pore may be less than a cross-sectional width of each perforation.

The method 300 also includes disposing (block 308) an electrolyte in the enclosure to initiate a pre-lithiation process in which Li+ ions are transferred from the lithium metal to the electrode (e.g., the anode) by way of the perforations. In embodiments employing multiple anodes, Li+ ions are transferred to each of the anodes. The perforations through the electrodes and the pores in the one or more separators may enable movement of the electrolyte and the Li+ ions about the interior of the enclosure. For example, the Li+ ions may be transferred from the lithium metal to the anode(s) during an electrolyte aging portion of the pre-lithiation process. The electrolyte aging portion of the pre-lithiation process may take, for example, less than one day or up to three days.

Presently disclosed embodiments employ a pre-lithiation assembly and corresponding process with lithium metal coating(s) on one or more interior surfaces of an enclosure (e.g., battery enclosure) to improve local voltage uniformity, battery stability, battery performance, and/or volumetric energy density and reduce, negate, and/or mitigate initial active lithium loss relative to traditional configurations.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S. C. 112(f). However, for any claims containing elements designated in any other manner, it is intended that such elements are not to be interpreted under 35 U.S. C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A battery pre-lithiation assembly, comprising:
an enclosure;
an electrode disposed in the enclosure and comprising a current collector, active material disposed on the current collector, and perforations extending through the active material and the current collector; and
a lithium metal coating on an interior surface of the enclosure, wherein the perforations are configured to enable migration of Li+ ions from the lithium metal coating to the electrode via a pre-lithiation process when the enclosure receives an electrolyte.

2. The battery pre-lithiation assembly of claim 1, comprising an additional electrode disposed in the enclosure and comprising an additional current collector, additional active material disposed on the additional current collector, and additional perforations extending through the additional active material and the additional current collector, wherein the additional perforations are configured to enable migration of the Li+ ions from the lithium metal coating to the electrode via the pre-lithiation process when the enclosure receives the electrolyte.

3. The battery pre-lithiation assembly of claim 2, wherein the electrode comprises an anode and the additional electrode comprises a cathode.

4. The battery pre-lithiation assembly of claim 2, wherein the electrode is coupled to the enclosure and the additional electrode is insulated from the enclosure.

5. The battery pre-lithiation assembly of claim 2, comprising a porous separator disposed between the electrode and the additional electrode.

6. The battery pre-lithiation assembly of claim 1, comprising an additional lithium metal coating disposed on an additional interior surface of the enclosure.

7. The battery pre-lithiation assembly of claim 1, wherein the electrode comprises additional perforations extending transverse to the perforations.

8. A battery pre-lithiation assembly, comprising:
an enclosure;
an anode disposed in the enclosure, wherein the anode comprises an anode current collector, anode active material disposed on the anode current collector, and first perforations extending through the anode current collector and the anode active material;
a cathode disposed in the enclosure, wherein the cathode comprises a cathode current collector, cathode active material disposed on the cathode current collector, and second perforations extending through the cathode current collector and the cathode active material; and
a lithium metal coating on an interior surface of the enclosure, wherein the first perforations and the second perforations are configured to enable migration of Li+ ions from the lithium metal coating to the anode via a pre-lithiation process.

9. The battery pre-lithiation assembly of claim 8, wherein the anode is coupled to the enclosure and the cathode is coupled to a terminal insulated from the enclosure.

10. The battery pre-lithiation assembly of claim 8, comprising an additional lithium metal coating on an additional interior surface of the enclosure.

11. The battery pre-lithiation assembly of claim 10, wherein the interior surface extends transverse to the additional interior surface.

12. The battery pre-lithiation assembly of claim 8, comprising a porous separator extending between the anode and the cathode.

13. The battery pre-lithiation assembly of claim 8, wherein:
the anode current collector is disposed between a first anode active material portion of the anode active material and a second anode active material portion of the anode active material;
the first perforations extend through the first anode active material portion and the second anode active material portion;
the cathode current collector is disposed between a first cathode active material portion of the cathode active material and a second cathode active material portion of the cathode active material; and
the second perforations extend through the first cathode active material portion and the second cathode active material portion.

14. The battery pre-lithiation assembly of claim 8, comprising an electrolyte disposed in the enclosure and configured to initiate the pre-lithiation process.

15. A method of manufacturing a battery, comprising:
disposing perforations through a current collector of an electrode and an active material of the electrode, wherein the active material is disposed on the current collector;
coating an interior surface of an enclosure with a lithium metal;
disposing the electrode in the enclosure; and
disposing an electrolyte in the enclosure to initiate a pre-lithiation process in which Li+ ions are transferred from the lithium metal to the electrode by way of the perforations.

16. The method of claim 15, comprising:
disposing additional perforations through an additional current collector of an additional electrode and an additional active material of the additional electrode, wherein the additional active material is disposed on the additional current collector;
disposing the additional electrode in the enclosure; and
disposing the electrolyte in the enclosure to initiate the pre-lithiation process in which the Li+ ions are transferred from the lithium metal to the electrode by way of the perforations and the additional perforations.

17. The method of claim 16, wherein the electrode is an anode and the additional electrode is a cathode.

18. The method of claim 16, comprising disposing a porous separator between the electrode and the additional electrode.

19. The method of claim 16, comprising:
coupling the electrode to the enclosure; and
insulating the additional electrode from the enclosure.

20. The method of claim 15, comprising coating an additional interior surface of the enclosure with an additional lithium metal.
